(19) United States
(12) Patent Application Publication
(10) Pub. No.: US 2004/0108147 A1
(43) Pub. Date: Jun. 10, 2004

(54) Wheelchair mobility unit

(76) Inventor: Vincent Ross, Liverpool (GB)

Correspondence Address: MACPHERSON KWOK CHEN & HEID LLP, 1762 TECHNOLOGY DRIVE, SUITE 226, SAN JOSE, CA, 95110, US

(21) Appl. No.: 10/467,969

(22) PCT Filed: Feb. 11, 2002
(86) PCT No.: PCT/GB02/00560

(30) Foreign Application Priority Data
Feb. 12, 2001 (GB) 0103280.4

(51) Int. Cl. B62M 7/14

(52) U.S. Cl. 180/13

(57) ABSTRACT

A conventional wheelchair (11) is powered by the hands and arms of the User. It normally has two large hand/arm driven rear wheels (17) and two small front castor-like wheels (19). The available powered chairs are expensive and complex, and not suitable for use both out on the street and also in inside at home or at work. The present invention furnishes a self-powered steerable mobility unit (21) that can be securely but removably attached in a matter of minutes to a wheelchair to provide superior mobility and yet increased stability and greater ease of use both indoors and out. More specifically, it proposes an arrangement rather like the front end of a bicycle—a powered wheel (22, 23) rotatably supported on a post (24) steerably/twistably mounted within a pillar (26) from which projects an elongate linear strut (121: the “connecting tube”), with steering handlebars (25) at the top end of the post (24) by which the wheel (22) may be turned from side to side—coupled with strut mounting means (125: the “docking tube”) secured to the wheelchair. The strut mounting means (125) is such as to allow the strut (121) initially to rotate on its axis therewithin, so that the powered wheel assembly (21) can be plugged into place while at an angle, and then rotated—by the User whilst sitting in the chair (11)—into the vertical while at the same time levering the wheelchair's front castor wheels (19) off the ground.

This invention is concerned with a wheelchair mobility unit—a unit that can be attached to many forms of wheelchair to provide them (and their Users) with improved mobility. More particularly, the invention concerns a device for converting a manually-powered wheelchair into a self-propelled tricycle.

A conventional wheelchair of the sort powered and driven by the hands and arms of the User is a chair with two large rear wheels that can be separately driven by hand/arm action (and that usually have rim-like grips to assist in this) and two small front castor-like wheels. The User may spend much of his (or her: hereafter “his” is used in that general sense) time sitting in such a chair, and it may provide the main way he can move around both inside (at home or at work) and outside (in the garden, along the pavement, from place to place, and so on).

For most purposes the User's muscle-power is sufficient, but there will be occasions when the distance to be travelled in the available time is such that muscles are not enough, and some form of powered chair is required. There are many powered chairs on the market, and they all work well, but they have the disadvantage that they are rather expensive and complex, and they are not really suitable for use both out on the street and also in inside at home or at work. Moreover, at or near their top speeds—most are notionally capable of around 10 miles per hour (about 15 kilometres per hour), but are in the majority of countries, including the United Kingdom, limited by law to nearer 4 mph (about 8 kph)—they tend to be somewhat unstable, especially on anything but the smoothest surface. What is required is some form of relatively-inexpensive “add-on” unit that can be utilised to provide the User's ordinary wheelchair with the sort of superior mobility provided by a powered chair and yet with increased stability and greater ease of use both indoors and out. And that is what the present invention seeks to furnish; a self-powered steerable mobility unit that can be securely but removably attached in a matter of minutes to a wheelchair. More specifically, there is proposed an arrangement rather like the front end of a bicycle—a powered wheel rotatably supported on a post steerably/twistably mounted within a pillar from which projects an elongate linear strut (the “top tube”, “cross bar”, or “connecting tube”), with steering means (handlebars) at the top end of the post by which the wheel may be turned from side to side—coupled with strut mounting means (a “docking tube”) “permanently” secured to the wheelchair. More specifically still, the proposed arrangement of the invention is one in which the mounting means by which the powered wheel assembly's strut is joined to the wheelchair is such as to allow the strut initially to rotate on its axis within the mounting means, so that the assembly can be plugged into place while at an angle, and then rotated—by the User whilst sitting in the chair—into the vertical while at the same time levering the wheelchair's front castor wheels off the ground. In use, then, the strut of the wheel portion is attached to the mounting means on the chair, to convert the chair into something very like a tricycle—but powered, of course—thus allowing the User to “drive” around outside at significantly-increased speed, but can subsequently be detached from the mounting means on the chair, thus returning the chair to its original, more conventional, indoors-suited form.

In one aspect, therefore, the invention provides a mobility unit for a wheelchair, which unit comprises the combination of

a powered wheel assembly steerably supported on a single projecting strut, together with

mounting means that can be securely fixed to, and centrally between the sides of, the wheelchair, and to which the strut's free end, and thus the wheel assembly, can be detachably attached, and wherein

the mounting means is one into which the strut fits and can twist, to provide a combination which is axially rotatable and, prior to being secured in place, can be so rotated both to orientate the wheel assembly vertically and to lever the front wheels of the chair off the ground.

The wheelchair may be of any variety. A typical fixed-frame one for long-term use by a paraplegic is that manufactured by Chevron, of Brunswick Business Park, Liverpool, under the name Model 500. An instance of a typical folding frame chair is that manufactured by [NAME], of [PLACE], under the name [NAME].

The powered wheel assembly is in essence the front half of a bicycle (or tricycle)—thus, a wheel rotatably supported on a post steerably/twistably mounted within a pillar from which projects a single elongate linear strut (the “top tube”, “connecting tube”, or “cross bar”), with steering means (handlebars) at the top end of the post by which the wheel may be turned from side to side—together with driving means to power it. These components may take any convenient form (for example, the post is preferably a conventional forked post, the handlebars are desirably the “upright” sort known as “high rise” or “allrounder”, and are foldable/collapsible/twistable between a “use” and a “stored” position that takes up less room, the strut (the “connecting tube”) is a substantial stiff tube welded to the pillar, and so on). A suitable driving means is a hub-mounted electric motor (such as that sold by Heinzman of Germany, or more preferably that sold by Singapore Technologies) together with its power source (a re-chargeable battery pack conveniently stored in a basket-like structure supported by the assembly's pillar), though other types—such as a small internal combustion motor with a friction drive to the wheel's tyre—are possible.

The assembly most preferably includes brakes and power-control means (conveniently incorporating a twist-grip throttle governing the output of the power source to the motor; the power-control means may also include facilities for key operation, as well as for battery-and fault-checking). The assembly may also include a steering centraliser (to assist in returning the wheel to the “straight-ahead” position after negotiating a bend)—for instance, a simple spring adjustably mounted between the steering post and the strut.

The unit includes mounting means that can be securely fixed to the wheelchair, and to which the strut's free end, and thus the wheel assembly, can be detachably attached. Although in principle almost any sort of mounting means could be used, fixed in any sort of way and with any mechanism for allowing the free end of the strut to be detachably attached thereto, in fact the invention utilises one special form—which is now described in more detail—in part because it solves one problem associated with any add-on unit, which is how to jack up the front of the wheelchair/unit combination, once the mobility unit is fitted in place, so as to raise the small front castor wheels off the ground.

This special mounting means is one that can be used—i.e., the wheel assembly can be attached through it to the chair—by the chair's Occupant even as he is actually sitting in the chair. Moreover, it is one into or onto which the strut can not only fit but in or on which it can, prior to being locked in place, twist. Thus, the mounting means, positioned in use centrally between the sides of the wheelchair, has an essentially circular-section tubular front end (and is indeed most preferably a tube, the “docking tube”), the strut has a matching circular-section free end (matching in the sense that the strut's external diameter is a close, but not tight, fit to the mounting means' tubular end's internal diameter; the strut, too, is most preferably a tube—the connecting tube—as noted above), and the two are fitted together so that the strut slides freely into (or onto; into is preferred) the mounting means tubular portion (to a chosen depth limited by a stop). Once in place the strut can be twisted about its axis.

Now, if the wheel assembly is so dimensioned (or adjustable) that when in its proper, use, position attached to the wheelchair the resulting vertical distance from the strut to the ground is slightly greater than the distance from the mounting means to the ground before the assembly is attached, then it must be put into place at a slight angle to the vertical, and when the assembly is twisted into the vertical—the handlebars and the pillar provide suitable leverage for this, even against the weight of the User sitting in the chair—this will automatically raise the front end of the chair, and thus the front wheels, off the ground.

Of course, having inserted and so twisted the strut (and thus the wheel assembly), it is necessary to fix it in place—to ensure that it doesn't either twist back or slide out. In the preferred mounting means of the invention this is achieved by having mounted at the free end of the strut, slightly spaced therefrom and parallel thereto, a cam-action clamping spigot with a large head, and providing on the mounting means a corresponding latch mechanism supported on the far side of a substantial, flange-like mounting, into which latch the spigot may be moved (as the strut is twisted) and retained thereby. And by then operating the clamp the spigot head is drawn towards the spigot mounting, thus clamping that mounting to the latch mounting, and binding the strut rigidly to the strut mounting means.

To remove the strut, and thus detach the wheel assembly, the spigot clamp is freed off, the latch is lifted, the assembly is pushed sideways to separate the spigot from the latch, and finally the assembly is simply pulled out.

Such a mounting means is shown in the accompanying Drawings.

The strut mounting means may, as noted above, be secured in any convenient way to the wheelchair. One such way involves clamping it semi-permanently—that is, with nuts and bolts and the like rather than with some sort of quick-release mechanism—to the framework making up the wheelchair's structure (and since there are several different structures for wheelchairs so the mounting means is designed to fit the appropriate structure). For example, with the Chevron chair mentioned above the mounting means is preferably secured both to the wheelchair's main axle (into which the large rear wheels are plugged) and to one of the chair's crossbars that support the actual seat portion. A different form of fixing is needed, though, with a folding chair (which has no rigid cross pieces, because it folds down one side into contact with the other), and for such a chair the mounting means incorporates its own (preferably telescopic) cross pieces which reach across and into engagement (conveniently utilising quick-release clamps at either end) with the lateral strengthening members that form part of each side of the chair.

In either case the tubular end of the mounting means, to which the strut is to be secured, is most preferably supported in such a way that its height can be adjusted to allow for different wheelchair structures, enabling the wheel assembly to be attached correctly regardless. One way to achieve this is to employ a mounting tubular end that can move in steps up/down between twin vertical support bars, to which it can be clamped (or otherwise secured) as appropriate.

Various embodiment of the invention are now described, though by way of illustration only, with reference to the accompanying diagrammatic Drawings in which:

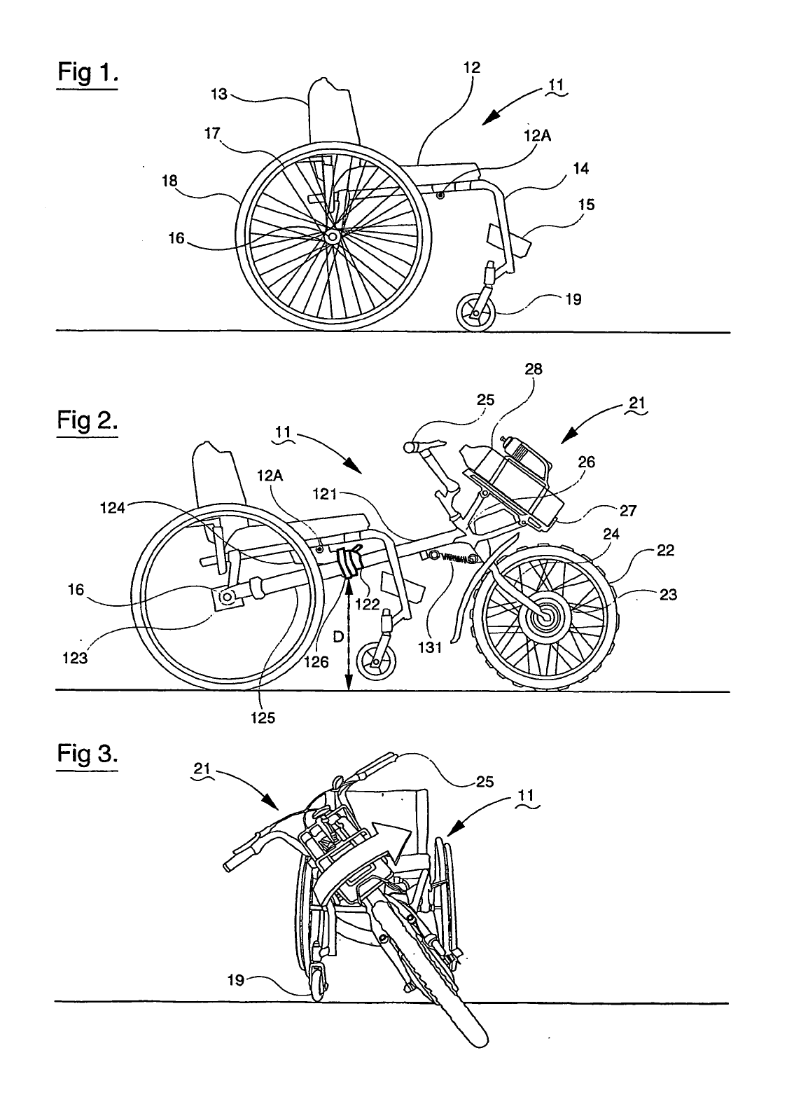

FIG. 1 shows a side view of a conventional non-foldable wheelchair;

FIG. 2 shows a side view of the wheelchair of FIG. 1 fitted with a mobility unit of the invention;

FIG. 3 shows a front view of the wheelchair/mobility unit combination of FIG. 2 during the attachment process;

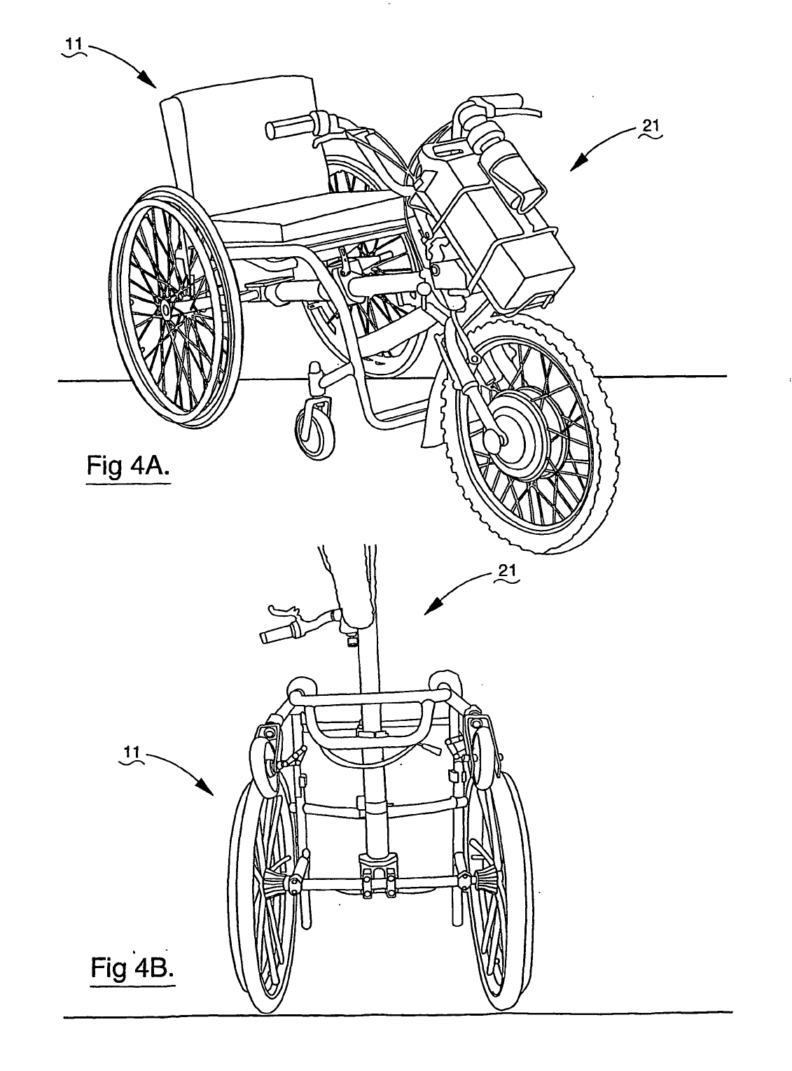

FIGS. 4A,B show respectively front perspective and part underneath views of a wheelchair fitted with a mobility unit of the invention (as in FIGS. 2&3);

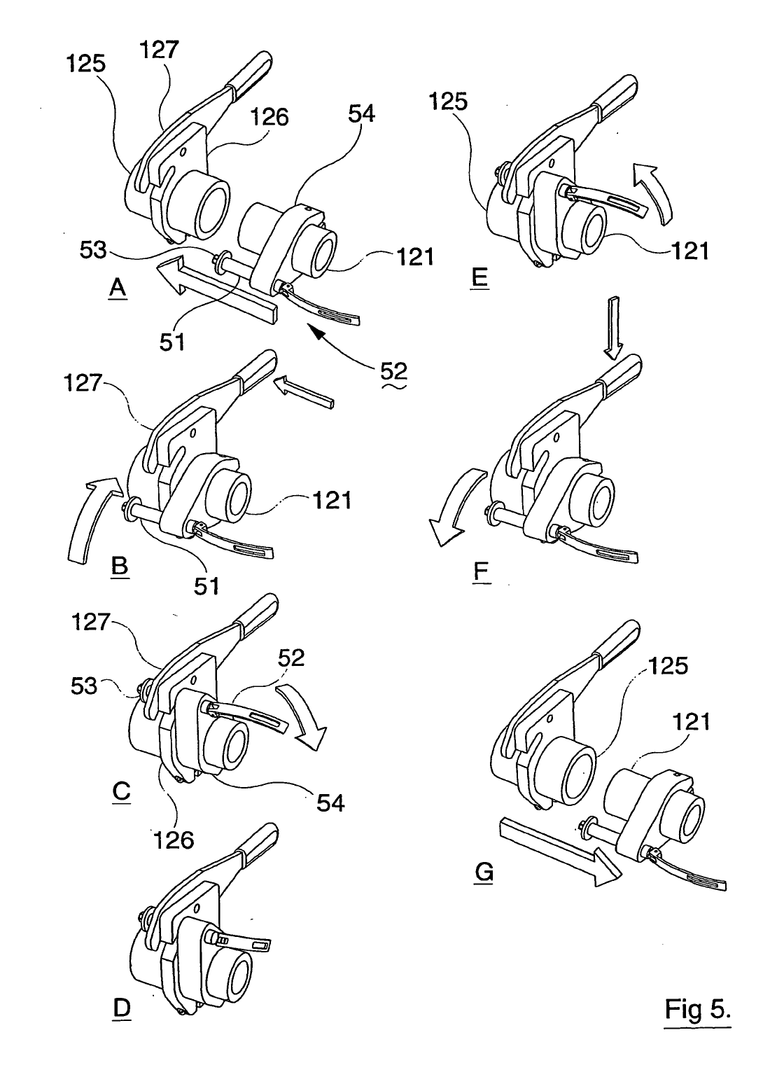

FIGS. 5A-G show, in stages, the process of attaching the strut to, and detaching it from, the mounting means;

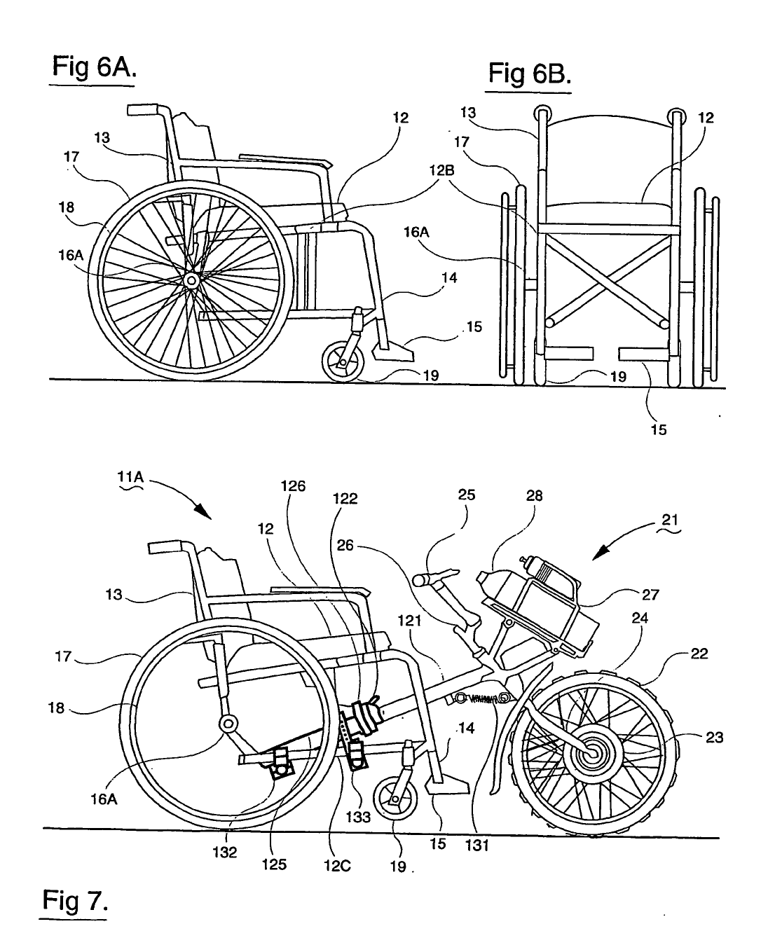

FIGS. 6A,B show respectively side and front views of a conventional foldable wheelchair;

FIG. 7 shows a side view of the wheelchair of FIG. 6 fitted with a mobility unit of the invention;

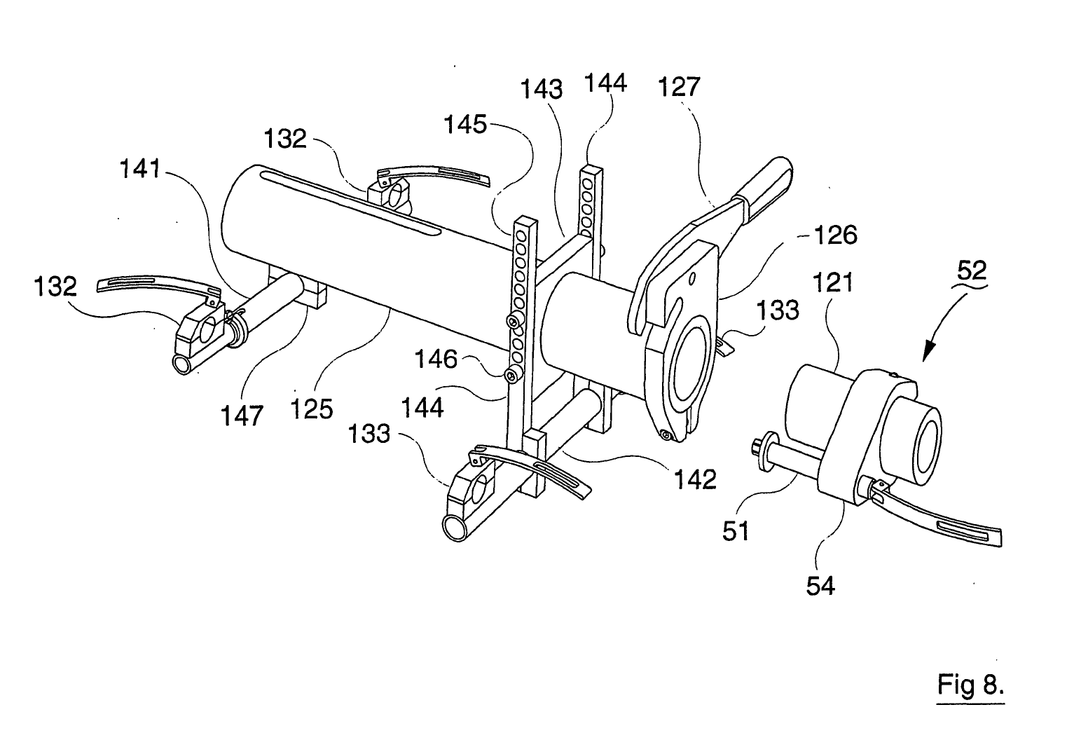

FIG. 8 shows details of a mounting system suitable for use with a folding wheelchair (as in FIGS. 6,7).

FIG. 1 shows a conventional wheelchair (generally 11). It has a User portion consisting of a seat (12) supported on a number of seat bars (one, 12A, is shown) with a back (13) and leg and foot supports (14,15) all carried by a frame, and these are mounted via an axle (16) on large hand-drivable rear wheels (17), each of which has a hand-rim (18), and on small front castors (19).

The same wheelchair is shown in FIG. 2, but with attached thereto a powered wheel assembly (generally 21) of the invention. The assembly comprises a front wheel (22) driven by a hub-mounted electric motor (23) rotatably mounted between the forks of a front post (24) itself mounted for steering by handles (25) in a pillar (26). The pillar 26 carries at the front a basket (27) holding a battery powerpack (28) operatively connected (by means not shown) and through control means (not shown) that include a twist grip on the handle 25. The handle also carries brakes (not shown).

Extending rearwardly from the wheel assembly's pillar 26 is a mounting strut 121 at the end of which is a parallel-mounted laterally-spaced spigot and clamp system (122: this whole system is best seen in FIG. 5). The strut 121 and the forks 24 are linked by a spring (123) to provide some slight centring effect

Underneath the wheelchair's seat 12, and fitted by suitable nut/bolt clamp means (shown generally as 123 and 124) secured respectively to the axle 16 and the seat support bar 12A is the mounting means by which the wheel assembly is releasably secured to the wheelchair. The mounting means is essentially a tube (125) that is fitted at its front end with a mounting flange (126) and an associated latch mechanism (127); these are best seen in FIG. 5, which is described hereinafter.

FIG. 3 shows a front view of the wheelchair/mobility unit combination of FIG. 2 during the attachment process. The distance D (when in the vertical, use, orientation: FIG. 2) of the wheel assembly from the strut 121 to the wheel's lowest point is greater than the distance from the tubular end of the mounting means 125 to the ground, so the only way to match the strut to the mounting means is to lean the assembly to one side, as shown. The strut can then be slid into the mounting means, and the handles 25 used to lever the assembly upright (as indicated by the arrow), lifting the wheel's front wheels 19 off the ground as this is done. As the levering continues, the spigot (51 in FIG. 5) moves into and is held by the latch mechanism 127, and then the cammed clamp (52 in FIG. 5) is operated to bind the whole together.

FIGS. 4A,B show respectively front perspective and part underneath views of a wheelchair fitted with a mobility unit of the invention (as in FIGS. 2&3).

FIGS. 5A-G show the process of attaching the strut to, and detaching it from, the mounting means.

In FIG. 5A the two parts are aligned, with the strut 121 and its clamping spigot 51/52 at a slight angle to the intended final arrangement—enough so that the lateral spigot 51 clears the hand-operable latching mechanism 127. The two are then pushed one into the other (FIG. 5B), and the strut 121 is twisted to cause the spigot 51 to engage the latch 127. The cammed clamp lever 52 is then operated (FIG. 5C), to draw the head (53) of the spigot 51 into engagement with the rear surface of the latch 127 and flange 126, binding the whole to the spigot support 54 (FIG. 5D).

FIGS. 5E-G show the strut 121 and mounting means tube 125 being detached. It is essentially the reverse of the attachment process, and needs no additional comments.

FIGS. 6A,B show respectively side and front views of a conventional foldable wheelchair, and FIG. 7 shows a side view of that wheelchair fitted with a mobility unit of the invention.

The foldable wheelchair is much like that non-foldable one (of FIG. 1), save that it has no rigid cross members, and so can be folded up, side-to-side, so as to become much “thinner” and so take up much less room. Like the non-foldable one, the FIG. 6 chair has a User portion consisting of a seat 12, but this is supported by being slung across from the two lateral bars (12B) one at each side of the chair. Also like the FIG. 1 chair this foldable one has a back 13, and on each side leg and foot supports 14,15 all carried by the appropriate side frame. Each side frame is mounted via a stub axle (16A) on large hand-drivable rear wheels 17, each of which has a hand-rim 18, and on small front castors 19.

The same wheelchair is shown in FIG. 7, but with attached thereto a powered wheel assembly 21 of the invention. As before, the assembly comprises a front wheel 22 driven by a hub-mounted electric motor 23 rotatably mounted between the forks of a front post 24 itself mounted for steering by handles 25 in a pillar 26. Also as before, the pillar 26 carries at the front a basket 27 holding a battery powerpack 28 operatively connected (by means not shown) and through control means (not shown) that include a twist grip on the handle 25. The handle also carries brakes (not shown). Extending rearwardly from the wheel assembly's pillar 26 is a mounting strut 121 at the end of which is a parallel-mounted laterally-spaced spigot and clamp system 122, and the strut 121 and the forks 24 are linked by a spring 131 to provide some slight centring effect.

FIG. 8 shows details of a mounting system suitable for use with such a folding wheelchair, as shown in FIG. 7.

As can clearly be seen, underneath the wheelchair's seat 12, and fitted by suitable quick-release clamps (shown generally as 132 and 133) secured—on each-side—to a lower lateral bar (12C) forming part of the chair's frame, is the mounting means by which the wheel assembly 21 is releasably secured to the wheelchair (generally 11A). The mounting means is essentially a tube 125 that is fitted at its front end with a mounting flange 126 and an associated latch mechanism 127. The tube 125 is secured to two cross-bars (141,142) that carry the quick-release clamps 132,133 at their ends. The tube 125 is mounted on the front cross-bar 142 by means of a height-adjustment system—a collar (143) that holds the tube and that slides up and down between two posts (144) each having a series of holes (as 145) through which bolts (as 146) can be passed to screw into the collar 143 and so hold the collar—and the tube—in place. The tube is mounted on the rear cross-bar 141 by a simple clamp (147) that when loose allows the tube to pivot slightly, so that it can be adjusted for height. When the adjustment is complete the clamp 147 is tightened up.

1. A mobility unit for a wheelchair, which unit comprises the combination of
a powered wheel assembly steerably supported on a single projecting strut, together with
mounting means that can be securely fixed to, and centrally between the sides of, the wheelchair, and to which the strut's free end, and thus the wheel assembly, can be detachably attached, and wherein
the mounting means is one into which the strut fits and can twist, to provide a combination which is axially rotatable and, prior to being secured in place, can be so rotated both to orientate the wheel assembly vertically and to lever the front wheels of the chair off the ground.

2. A mobility unit as claimed in claim 1, wherein the driving means is a hub-mounted electric motor together with its power source.

3. A mobility unit as claimed in claim 2, wherein the power source is a re-chargeable battery pack stored in a basket-like structure supported by the assembly's pillar.

4. A mobility unit as claimed in any of the preceding Claims, wherein the assembly includes power-control means incorporating a twist-grip throttle governing the output of the power source to the motor.

5. A mobility unit as claimed in any of the preceding Claims, wherein the power-control means includes facilities for key operation, as well as for battery-and fault-checking.

6. A mobility unit as claimed in any of the preceding Claims, wherein the assembly includes a steering centraliser to assist in returning the wheel to the “straight-ahead” position after negotiating a bend.

7. A mobility unit as claimed in claim 6, wherein the centraliser is a spring adjustably mounted between the steering post and the strut.

8. A mobility unit as claimed in any of the preceding Claims, wherein the mounting means is positioned in use centrally between the sides of the wheelchair, and has a circular-section tubular front end, the strut has a matching circular-section free end, and the two are fitted together so that the strut slides freely into or onto the mounting means tubular portion.

9. A mobility unit as claimed in claim 8, wherein the mounting means is a tube, and the sliding thereinto of the strut is to a chosen depth limited by a stop.

10. A mobility unit as claimed in any of the preceding Claims, wherein, once inserted into and appropriately twisted within the mounting means, the strut—and thus the wheel assembly—is secured in place by having mounted at the free end of the strut, slightly spaced therefrom and parallel thereto, a cam-action clamping spigot with a large head, and providing on the mounting means a corresponding latch mechanism supported on the far side of a substantial, flange-like mounting, into which latch the spigot may be moved (as the strut is twisted) and retained thereby, such that by appropriately operating the clamp the spigot head is drawn towards the spigot mounting, thus clamping that mounting to the latch mounting, and binding the strut rigidly to the strut mounting means.

11. A mobility unit as claimed in any of the preceding Claims, wherein the strut mounting means is secured to the wheelchair using quick-release clamps attaching it to the framework making up the wheelchair's structure.

12. A mobility unit as claimed in any of the preceding Claims and substantially as described hereinbefore.
